(19) United States
(12) Patent Application Publication
(10) Pub. No.: US 2024/0136661 A1
(43) Pub. Date: Apr. 25, 2024

(54) SEPARATOR AND LITHIUM-ION BATTERY INCLUDING THE SAME

(71) Applicant: ZHUHAI COSMX BATTERY CO., LTD., Zhuhai (CN)

(72) Inventors: Junyi ZHAO, Zhuhai (CN); Suli LI, Zhuhai (CN); Junyi LI, Zhuhai (CN)

(73) Assignee: ZHUHAI COSMX BATTERY CO., LTD., Zhuhai (CN)

(21) Appl. No.: 18/400,945

(22) Filed: Dec. 29, 2023

Related U.S. Application Data
(63) Continuation-in-part of application No. PCT/CN2022/129949, filed on Nov. 4, 2022.

(30) Foreign Application Priority Data
Nov. 4, 2021 (CN) 202111307928.0

(51) Int. Cl. H01M 50/454; H01M 50/417

(52) U.S. Cl. CPC H01M 50/454; H01M 50/417; H01M 10/0525

(57) ABSTRACT

Disclosed are a separator and a lithium-ion battery including the separator. The separator includes a coating; the coating includes a first additive and a second additive, and a mass ratio of the first additive to the second additive ranges from 1:9 to 9:1; and the coating includes a plurality of adhesive layer holes, and a pore diameter of the adhesive layer hole ranges from 0.01 μm to 10 μm. In the present disclosure, an electrostatic adsorption capability of a surface on a separator coated with an oil or an oil mixture is reduced, so that fewer particles can be adsorbed, and a self-discharge value of a battery cell can be reduced, thereby improving quality of the battery cell.

### CROSS-REFERENCE TO RELATED APPLICATIONS

The present disclosure is a continuation-in-part of International Application No. PCT/CN2022/129949, filed on Nov. 4, 2022, which claims priority to Chinese Patent Application No. 202111307928.0, filed on Nov. 5, 2021. Both of the aforementioned applications are hereby incorporated by reference in their entireties.

### TECHNICAL FIELD

The present disclosure pertains to the field of separator technologies, and in particular, to a separator and a lithium-ion battery that includes the separator.

### BACKGROUND

A currently used separator is a polyolefin product (for example, polyethylene (PE), polypropylene (PP), or three layers of PP/PE/PP) with a porous structure. Inorganic particles (such as aluminum oxide, boehmite, magnesium oxide, or magnesium hydroxide) are applied on one or two sides of the base material separator. On such a basis, single-sided or double-sided coating is performed by using pure adhesive or mixture of adhesive and ceramic particles (the adhesive may be a single polyvinylidene fluoride (PVDF) or a mixture of a plurality of PVDFs). The coating manner may be water-based coating or oil-based coating.

In different processing modes, electrostatic values of a surface of a separator are different. For example, an electrostatic value of a water-based separator is less than 300 V, an electrostatic value of a one-sided ceramic and double-sided oil-based product is about 1000 V, and an electrostatic value of a double-sided separator coated with a ceramic and oil-based mixture is as high as 3000 V or greater. Such separators usually have relatively large static electricity when being used to prepare a lithium-ion battery, and may absorb particles in air, causing the inside of a cell of the lithium-ion battery to be in a micro-short circuit state (For example, a voltage drop of the cell is very obvious, and a maximum value may reach 0.1 mV/h or greater).

### SUMMARY

In the present disclosure, an additive is introduced into a separator. The additive forms a structure having a low electrostatic function on a surface of the separator to reduce an electrostatic value of the separator, which can have a low electrostatic and high process capability without reducing adhesion between the separator and an electrode plate. For example, a battery has a relatively high yield rate, and a core pulling defect rate and a Hi-Pot defect rate can be at a relatively low level.

The present disclosure provides the following technical solutions.

A separator is provided, including a coating, where the coating includes a first additive and a second additive, and a mass ratio (g:g) of the first additive to the second additive ranges from 1:9 to 9:1. The coating includes a plurality of adhesive layer holes, and a pore diameter of the adhesive layer hole ranges from 0.01 μm to 10 μm.

In an example, the mass ratio (g:g) of the first additive to the second additive ranges from 2:8 to 8:2.

In an example, in the adhesive layer holes, a quantity of adhesive layer holes with a pore diameter ranging from 1 μm to 3 μm accounts for 30%-70% of a total quantity of adhesive layer holes.

In an example, the second additive is organic microspheres, and the organic microspheres meet at least one of the following conditions:
(1) a weight-average molecular weight of an organic matter in the organic microspheres ranges from 1×10⁵ Da to 30×10⁵ Da;
(2) a median particle size Dv50 of the organic microspheres ranges from 0.1 μm to 300 μm;
(3) a melting point of an organic matter in the organic microspheres ranges from 100° C. to 400° C.;
(4) an organic matter in the organic microspheres is selected from at least one of a fluorine-containing polymer or an acrylate polymer;
(5) the organic microspheres are partially or rarely dissolved in an organic solvent, to form a mesh structure; or
(6) an organic matter in the organic microspheres is selected from at least one of polyvinylidene fluoride (PVDF), polytetrafluoroethylene (PTFE), polyethylene (PE), or polymethyl methacrylate (PMMA).

In an example, the first additive is connected to a surface of the second additive in a long-chain grid shape.

In an example, the first additive is selected from PVDF, and has a melting point ranging from 150° C. to 160° C. and a weight-average molecular weight ranging from 3×10⁵ Da to 7×10⁵ Da.

In an example, the separator includes a base material layer and the coating located on at least one surface of the base material layer, and a thickness of the coating ranges from 0.1 μm to 3 μm.

In an example, when the coating is disposed on two surfaces of the base material layer, the separator includes two coatings, and a total thickness of the two coatings ranges from 0.2 μm to 5 μm.

In an embodiment, a thickness of the base material layer ranges from 1 μm to 30 μm.

In an example, the base material layer is selected from a single-layer base material layer or a multi-layer base material layer consisting of PE and/or PP.

In an example, the separator is an oil-based separator.

In an example, an average electrostatic value of the separator is less than 1500 V.

In an example, an average self-discharge value of the separator is less than 0.045 mV/h.

The present disclosure further provides a lithium-ion battery, and the lithium-ion battery includes the foregoing separator.

Beneficial Effects are as Follows:

In the present disclosure, a second additive organic matter is introduced on a surface of a separator, so that the organic matter is partially crosslinked with a first additive in a solvent system. In addition, most of the second additive organic matter further retains its original complete form and can form a spherical connection phenomenon with the first additive, such that surfaces of different spheres are connected to each other, thereby forming a multilayer honeycomb structure, which can form a lot of large giant mesh structures, significantly reducing an electrostatic value of an oil-based separator, for example, from 3000 V or greater to 1200 V or less. In the present disclosure, an electrostatic adsorption capability on a surface of an oil-based separator is reduced, so that fewer particles can be adsorbed, and a self-discharge value of a battery cell can be reduced, thereby improving quality of the battery cell.

In the present disclosure, organic microspheres of the second additive are introduced to a surface of a separator to form a mesh structure with a first additive. The separator of the present disclosure may be used to replace ceramic particles that are currently introduced into a coating, so as to reduce surface energy of the coating on the surface of the separator and reduce the electrostatic value on the surface of the separator.

### BRIEF DESCRIPTION OF THE DRAWINGS

FIG. 1 is a schematic diagram of an organic matter in a coating according to the present disclosure, where black balls represent a second additive, and lines represent a first additive.

FIG. 2 is a scanning electron microscope (SEM) diagram of a surface of a separator in Example I4a.

FIG. 3 is an SEM diagram of a surface of a separator in Example I4b.

FIG. 4 is an SEM diagram of a surface of a separator in Example I4c.

FIG. 5 is an SEM diagram of a surface of a separator in Example I1.

FIG. 6 is an SEM diagram of a surface of a separator in Comparative Example 1.

FIG. 7 is a schematic diagram of core pulling of a jelly roll.

### DETAILED DESCRIPTION OF THE EMBODIMENTS

As previously described, the present disclosure provides a coating, and the coating includes a first additive and a second additive. The coating includes a plurality of adhesive layer holes, and a pore diameter of the adhesive layer hole ranges from 0.01 μm to 10 μm, for example, is 0.01 μm, 0.05 μm, 0.1 μm, 0.2 μm, 0.3 μm, 0.4 μm, 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, or 10 μm.

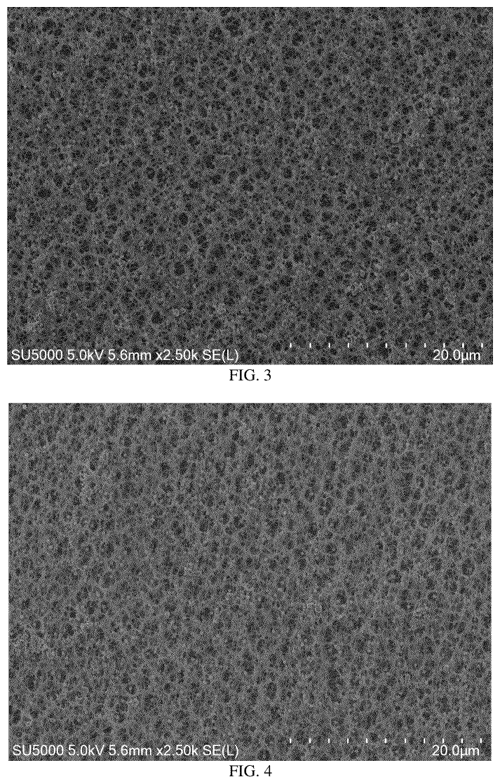

According to an implementation of the present disclosure, the first additive and the second additive form a multi-angle interconnected mesh structure in the coating, and the mesh structure includes the plurality of adhesive layer holes, which is specifically shown in FIG. 2 or FIG. 3.

According to an implementation of the present disclosure, in the adhesive layer holes, a quantity of adhesive layer holes with a pore diameter ranging from 1 μm to 3 μm (including two point values) (for example, the pore diameter is 1 μm, 1.5 μm, 2 μm, 2.5 μm, or 3 μm) accounts for 30%-70% (for example, 30%, 35%, 40%, 45%, 50%, 55%, 60%, 65%, or 70%) of a total quantity of adhesive layer holes. Such a pore diameter, especially such pore diameter distribution, is selected because such pore diameter distribution can form layer-like and porous distribution, and a specific surface area of an oil-based separator can be increased, thereby reducing a probability of electrostatic generation in processes of coating, cutting, and use of the separator, and facilitating use of the separator. For example, when a proportion of the adhesive layer holes with the pore diameter being less than 1 μm is high (for example, 40% or more), an electrostatic value of the separator is obviously high (more than 2000 V), which is not conducive to production. In addition, if all adhesive layer holes are in the pore diameter (1 μm-3 μm), an adhesive force between the adhesive layer and an electrode plate becomes weak, and a range from 30% to 70% is selected.

According to an implementation of the present disclosure, the second additive is organic microspheres, and a weight-average molecular weight of an organic matter in the organic microspheres ranges from 1×10⁵ Da to 30×10⁵ Da, for example, may be 1×10⁵ Da, 2×10⁵ Da, 3×10⁵ Da, 4×10⁵ Da, 5×10⁵ Da, 6×10⁵ Da, 7×10⁵ Da, 8×10⁵ Da, 8.5×10⁵ Da, 9×10⁵ Da, 10×10⁵ Da, 11×10⁵ Da, 12×10⁵ Da, 13×10⁵ Da, 14×10⁵ Da, 15×10⁵ Da, 20×10⁵ Da, or 30×10⁵ Da.

Specifically, the weight-average molecular weight of the organic matter in the organic microspheres ranges from 8×10⁵ Da to 10×10⁵ Da, or from 10×10⁵ Da to 30×10⁵ Da. The inventors found that the greater the molecular weight of the organic matter in the organic microspheres, the greater the polarity, and the longer the molecular chain. In this case, the longer it takes for the organic matter to dissolve in an organic solvent, the more conducive to forming the foregoing mesh structure. In addition, the more obvious a layered structure of the structure, the more obvious an antistatic effect.

According to an implementation of the present disclosure, a median particle size Dv50 of the organic microspheres ranges from 0.1 μm to 300 μm, for example, is 0.1 μm, 0.3 μm, 1 μm, 2 μm, 3 μm, 3.5 μm, 3.724 μm, 4 μm, 5 μm, 10 μm, 50 μm, 100 μm, 200 μm, or 300 μm. For example, the median particle size Dv50 of the organic microspheres ranges from 0.3 μm to 10 μm, and specifically, ranges from 0.3 μm to 5 μm. Selecting microspheres with such particle size distribution aims to ensure that a smaller median particle size Dv50 of the organic microspheres results in a more uniform mesh structure, and a smaller median particle size Dv50 facilitates coating control.

According to an implementation of the present disclosure, a melting point of an organic matter in the organic microspheres ranges from 100° C. to 400° C., and specifically, the melting point may be 100° C., 110° C., 120° C., 130° C., 140° C., 145° C., 150° C., 155° C., 160° C., 170° C., 180° C., 190° C., 200° C., 250° C., 300° C., 350° C., or 400° C. For example, the melting point ranges from 140° C. to 155° C., the melting point ranges from 160° C. to 180° C., or the melting point ranges from 310° C. to 340° C. When the melting point of the organic matter is too low, a glass transition temperature of the organic matter is low, which is not conducive to the separator application. When the melting point of the organic matter is too high, crystallinity of the organic matter is too high to form the mesh structure.

According to an implementation of the present disclosure, an organic matter in the organic microspheres is selected from at least one of a fluorocarbon polymer or an acrylate polymer, and the organic microspheres are partially or rarely dissolved in an organic solvent (such as NMP or DMAC), thereby becoming a basis for forming the foregoing mesh structure, and further forming the foregoing mesh structure by means of interconnection of a first additive.

According to an implementation of the present disclosure, the organic matter in the organic microspheres is selected from at least one of polyvinylidene fluoride (PVDF), polytetrafluoroethylene (PTFE), polyethylene (PE), or polymethyl methacrylate (PMMA).

For example, the organic matter in the organic microspheres is selected from PVDF and has properties of the foregoing organic matter, such as weight-average molecular weight and melting point.

According to an implementation of the present disclosure, the first additive is selected from an organic matter, and the organic matter includes an organic matter in organic microspheres of a second additive. The first additive is connected to the surface of the second additive (such as the organic microspheres) in a long-chain grid shape, so as to form the mesh structure.

For example, the first additive is selected from PVDF, has a melting point ranging from 150° C. to 160° C. and a weight-average molecular weight ranging from 3×10⁵ Da to 7×10⁵ Da.

According to an implementation of the present disclosure, a mass ratio (g:g) of the first additive to the second additive ranges from 1:9 to 9:1. Specifically, a combination may be performed according to solubility or molecular weight of the first additive and the second additive, for example, the mass ration is 1:9, 2:8, 3:7, 4:6, 5:5, 6:4, 7:3, 8:2, or 9:1. The foregoing mesh structure is obtained by adjusting the mass ratio of the first additive to the second additive. If only the second additive is added, it is not conducive to forming the foregoing mesh structure.

According to an implementation of the present disclosure, the mass ratio (g:g) of the first additive to the second additive ranges from 2:8 to 8:2.

The present disclosure further provides a separator, and the separator includes the foregoing coating.

According to an implementation of the present disclosure, the separator includes a base material layer and a coating layer provided on at least one surface of the base material layer.

According to an implementation of the present disclosure, when the coating is disposed on one surface of the base material layer, the separator includes one coating, and a thickness of the one coating ranges from 0.1 μm to 3 μm; (for example, 0.1 μm, 0.5 μm, 1 μm, 1.5 μm, 2 μm, 2.5 μm, or 3 μm), for example, ranges from 0.8 μm to 1.2 μm.

According to an implementation of the present disclosure, when the coating is disposed on two surfaces of the base material layer, the separator includes two coatings, and a total thickness of the two coatings ranges from 0.2 μm to 5 μm (for example, 0.2 μm, 0.5 μm, 1 μm, 1.5 μm, 2 μm, 2.5 μm, 3 μm, 3.5 μm, 4 μm, 4.5 μm, or 5 μm), for example, ranges from 1.8 μm to 2.2 μm.

According to an implementation of the present disclosure, the base material layer is selected from a single-layer base material layer or a multi-layer base material layer consisting of PE and/or PP. For example, the base material layer is selected from a three-layer base material layer of the PP/PE/PP.

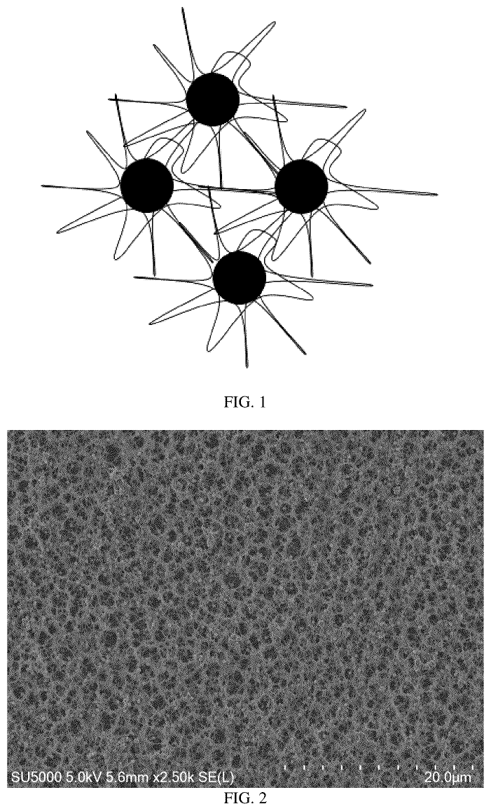

According to an implementation of the present disclosure, the second additive forms a stable skeleton support in the coating (as shown in FIG. 1), and a coating on a surface of the base material layer can be protruded, so that adhesive layer holes are formed on a surface of the coating, and the adhesive layer holes form the mesh structure by means of interconnection of the first additive, which is specifically shown in FIG. 2 or FIG. 3.

According to an implementation of the present disclosure, a thickness of the base material layer ranges from 1 μm to 30 μm, for example, is 1 μm, 5 μm, 10 μm, 15 μm, 20 μm, 25 μm, or 30 am.

According to an implementation of the present disclosure, the separator is an oil-based separator.

In the present disclosure, the term “oil-based separator” has a conventional meaning in the art, generally means that a solvent used to form a slurry of a coating in a separator is an organic solvent.

According to an implementation of the present disclosure, an average electrostatic value of the separator is less than 1500 V. The inventors found that when the average electrostatic value of the separator is less than 1500 V, a capability of the separator to adsorb particles in the air decreases, so that the separator can adsorb fewer particles, thereby reducing a probability of a foreign object being introduced into a battery cell body.

According to an implementation of the present disclosure, an average electrostatic value of the separator is less than 1200 V.

According to an implementation of the present disclosure, an average self-discharge value of the separator is less than 0.045 mV/h. The inventors found that when a separator with such an average self-discharge value is applied to a battery, long-term storage performance of a single battery is good, a serial voltage difference of a plurality of batteries is small, and a battery failure rate is reduced.

According to an implementation of the present disclosure, the separator is less likely to absorb a light and small object in a use process, and a probability that a foreign object enters a battery cell body can be reduced.

The present disclosure further provides a lithium-ion battery, where the lithium-ion battery includes the foregoing separator.

According to an implementation of the present disclosure, the lithium-ion battery further includes a positive electrode.

According to an implementation of the present disclosure, the positive electrode at least includes a positive electrode current collector, a positive electrode coating, and a positive tab.

According to an embodiment of the present disclosure, the positive electrode current collector is selected from aluminum foil, and a thickness of the aluminum foil ranges from 8 μm to 14 μm, for example, is 8 μm, 9 μm, 10 μm, 11 μm, 12 μm, 13 μm, or 14 μm.

According to an implementation of the present disclosure, the positive electrode coating includes a positive electrode active material, a positive electrode conductive agent, and a positive electrode binder.

According to an implementation of the present disclosure, the positive electrode active material is selected from at least one of LiCoO₂, LiNiO₂, LiFePO₄, LiMn₂O₄, or LiNiₓCo_{y}Mn_{1-x-y} O₂.

According to an implementation of the present disclosure, the positive electrode conductive agent is selected from at least one of conductive carbon black, carbon nanotubes, conductive graphite, or graphene.

According to an implementation of the present disclosure, the positive electrode binder is selected from at least one of polyvinylidene fluoride, a vinylidene fluoride-fluorinated olefin copolymer, polytetrafluoroethylene, sodium carboxymethyl cellulose, styrene-butadiene rubber, polyurethane, fluorinated rubber, or polyvinyl alcohol.

According to an implementation of the present disclosure, in the positive electrode coating, a mass fraction of the positive electrode active material ranges from 96% to 98.5% (for example, 96%, 96.5%, 97%, 97.5%, 98%, or 98.5%), a mass fraction of the positive electrode conductive agent ranges from 0.5% to 2.5% (for example, 2.5%, 2%, 1.5%, 1%, or 0.5%), and a mass fraction of the positive electrode binder ranges from 1% to 1.5% (for example, 1.5%, or 1%).

According to an implementation of the present disclosure, the lithium-ion battery further includes a negative electrode.

According to an implementation of the present disclosure, the negative electrode includes a negative electrode current collector, a negative electrode coating, and a negative tab.

According to an implementation of the present disclosure, the negative electrode coating includes a negative electrode active material, a negative electrode conductive agent, a negative electrode binder, and a dispersing agent.

According to an implementation of the present disclosure, the negative electrode active material is selected from at least one of mesocarbon microbead, artificial graphite, natural graphite, hard carbon, soft carbon, lithium titanate, silicon-based material, tin-based material, or a lithium metal.

According to an implementation of the present disclosure, the negative electrode conductive agent is selected from at least one of conductive carbon black, carbon nanotubes, conductive graphite, or graphene.

According to implementations of the present disclosure, the negative electrode binder is selected from at least one of polyvinylidene fluoride, a vinylidene fluoride-fluorinated olefin copolymer, polytetrafluoroethylene, sodium carboxymethyl cellulose, styrene-butadiene rubber, polyurethane, fluorinated rubber, and polyvinyl alcohol.

According to an implementation of the present disclosure, the dispersing agent is selected from sodium carboxymethyl cellulose and/or potassium carboxymethyl cellulose.

According to an implementation of the present disclosure, in the negative electrode coating, a mass fraction of the negative electrode active material ranges from 91% to 98.6% (for example, 91%, 92%, 93%, 94%, 95%, 96%, 97%, 98%, or 98.6%), a mass fraction of the negative electrode conductive agent ranges from 0.1% to 3% (for example, 3%, 2%, 1%, 0.5%, or 0.1%), a mass fraction of the negative electrode binder ranges from 0.6% to 3% (for example, 3%, 2%, 1%, or 0.6%), and a mass fraction of the dispersing agent ranges from 0.6% to 3% (for example, 3%, 2%, 1%, or 0.6%).

According to an implementation of the present disclosure, in the negative electrode coating, a mass fraction of the negative electrode active material ranges from 95% to 97%, a mass fraction of the negative electrode conductive agent ranges from 1% to 2%, a mass fraction of the negative electrode binder ranges from 1% to 1.5%, and a mass fraction of the dispersing agent ranges from 1% to 1.5%.

The following further describes the technical solutions of the present disclosure in detail with reference to specific embodiments. It should be understood that the following embodiments are merely illustrative and illustrative of the present disclosure, and should not be construed as limiting the scope of the present disclosure. Any technology implemented based on the foregoing contents of the present disclosure falls within the intended protection scope of the present disclosure.

Unless otherwise stated, raw materials and reagents used in the following examples are commercially available commodities, or may be prepared by using a known method.

The abbreviations in the present disclosure are as follows: DMAC refers to dimethylacetamide; and DMF refers to N, N-dimethylformamide.

The electrostatic value in the present disclosure is obtained through a KEYENCE SK-H050 test. An average value of electrostatic values of respective groups of separators is an average electrostatic value.

In examples of the present disclosure, numerical ranges of the “average electrostatic value” and the “average self-discharge value” are obtained by using the following method. The following uses the “average electrostatic value” as an example for description. 50 separators prepared in Example I1 are randomly divided into five groups, and each group has 10 separators. An electrostatic value of each separator is obtained by means of test, and an average electrostatic value of respective groups of separators is obtained by means of calculation. In this case, an average electrostatic value of the five groups of separators is in the numerical ranges shown in Table 2.

### Example I1

A first additive (conventional PVDF, with a melting point ranging from 150° C. to 160° C. and a weight-average molecular weight ranging from 3×10⁵ Da to 7×10⁵ Da) and a second additive (PVDF microspheres, a melting point is 145° C.±5° C., a weight-average molecular weight ranges from 8×10⁵ Da to 10×10⁵ Da, and a median particle size Dv50 of the microspheres is 3.724 μm) were used for coating and production at a mass ratio of 30:70. A separator base material is PE, with a thickness of 5 μm. A solid content of a slurry for coating is 7.5%, and a solvent is DMAC. The slurry was stirred for 30 minutes, and a viscosity of the slurry was controlled from 130 mPa s to 180 mPa·s for coating (double-sided coating). The coated separator was immersed in an extraction tank (a water temperature in the extraction tank was 25° C.), and a total thickness of two coatings was 2 μm. After coating, an oil-based separator 1 was obtained.

### Example 12

A first additive (conventional PVDF, with a melting point ranging from 150° C. to 160° C. and a weight-average molecular weight ranging from 3×10⁵ Da to 7×10⁵ Da) and a second additive (PVDF microspheres, a melting point is 145° C.±5° C., a weight-average molecular weight ranges from 8×10⁵ Da to 10×10⁵ Da, and a median particle size Dv50 of the microspheres is 0.5 μm) were used for coating and production at a mass ratio of 40:60. A separator base material is PE, with a thickness of 5 μm. A solid content of a slurry for coating is 7.5%, and a solvent is DMAC. The slurry was stirred for 30 minutes, and a viscosity of the slurry was controlled from 130 mPa·s to 180 mPa·s for coating (double-sided coating). The coated separator was immersed in an extraction tank (a water temperature in the extraction tank was 20° C.), and a total thickness of two coatings was 1 μm. After coating, an oil-based separator 2 was obtained.

### Example 13

A first additive (conventional PVDF, with a melting point ranging from 150° C. to 160° C. and a weight-average molecular weight ranging from 3×10⁵ Da to 7×10⁵ Da) and a second additive (PVDF microspheres, a melting point is 145° C.±5° C., a weight-average molecular weight ranges from 8×10⁵ Da to 10×10⁵ Da, and a median particle size Dv50 of the microspheres is 4.5 μm) were used for coating and production at a mass ratio of 20:80. A separator base material is PE, with a thickness of 5 μm. A solid content of a slurry for coating is 7.5%, and a solvent is DMAC. The slurry was stirred for 60 minutes, and a viscosity of the slurry was controlled from 130 mPa·s to 180 mPa·s for coating (double-sided coating). The coated separator was immersed in an extraction tank (a water temperature in the extraction tank was 30° C.), and a total thickness of two coatings is 3 μm. After coating, an oil-based separator 3 was obtained.

### Example 14

For this example group, reference is made to Example I1. A difference lies in that a mass proportion of a second additive PVDF microspheres in a total PVDF is changed, and details are as follows.

In Example I4a, a mass ratio of a first additive to a second additive is 90:10. In this case, an oil-based separator 4a was obtained.

In Example I4b, a mass ratio of a first additive to a second additive is 70:30. In this case, an oil-based separator 4b was obtained.

In Example I4c, a mass ratio of a first additive to a second additive is 50:50. In this case, an oil-based separator 4c was obtained.

### Example I5

For this example group, reference is made to Example I1. A difference lies in that pore diameter distribution of adhesive layer holes is changed, and details are as follows.

In Example I5a, by changing a water temperature of an extraction tank to 10° C., in adhesive layer holes, a quantity of adhesive layer holes with a pore diameter ranging from 1 μm to 3 μm accounted for 25% of a total quantity of adhesive layer holes. In this case, an oil-based separator 5a was obtained.

In Example I5b, by changing a water temperature of an extraction tank to 55° C., in adhesive layer holes, a quantity of adhesive layer holes with a pore diameter ranging from 1 μm to 3 μm accounted for 80% of a total quantity of adhesive layer holes. In this case, an oil-based separator 5b was obtained.

### Example 16

For this example group, reference is made to Example I1. A difference lies in that a weight-average molecular weight of a second additive PVDF microspheres is changed, and details are as follows.

In Example I6a, a weight-average molecular weight of a second additive PVDF microspheres ranges from 15×10⁵ Da to 20×10⁵ Da. In this case, an oil-based separator 6a was obtained.

In Example I6b, a weight-average molecular weight of a second additive PVDF microspheres ranges from 25×10⁵ Da to 30×10⁵ Da. In this case, an oil-based separator 6b was obtained.

In Example I6c, a weight-average molecular weight of a second additive PVDF microspheres ranges from 6×10⁵ Da to 7×10⁵ Da. In this case, an oil-based separator 6c was obtained.

### Example 17

For this example group, reference is made to Example I1. A difference lies in that a median particle size Dv50 of a second additive PVDF microspheres is changed, and details are as follows.

In Example I7a, a median particle size Dv50 of a second additive PVDF microsphere is 0.3 μm. In this case, an oil-based separator 7a was obtained.

In Example I7b, a median particle size Dv50 of a second additive PVDF microsphere is 10 μm. The slurry was stirred for 120 minutes to obtain an oil-based separator 7b.

### Example I8

For this example group, reference is made to Example I1. A difference lies in that a second additive is changed, and details are as follows.

In Example I8a, a second additive was replaced with PTFE microspheres with a same mass (a melting point ranges from 310° C. to 340° C., a weight-average molecular weight ranges from 1×10⁵ Da to 3×10⁵ Da, and a median particle size Dv50 of the microspheres is 2.55 μm). In this case, an oil-based separator 8a was obtained.

In Example I8b, a second additive was replaced with PMMA microspheres with a same mass (a melting point ranges from 160° C. to 180° C., a weight-average molecular weight ranges from 1×10⁵ Da to 5×10⁵ Da, and a median particle size Dv50 of the microspheres is 3.55 μm). In this case, an oil-based separator 8b was obtained.

In Example I8c, a second additive was replaced with PE microspheres with a same mass (a melting point ranges from 120° C. to 140° C., a weight-average molecular weight ranges from 5×10⁵ Da to 8×10⁵ Da, and a median particle size Dv50 of the microspheres is 3.15 μm) In this case, an oil-based separator 8c was obtained.

### Example I9

For this example group, reference is made to Example I1. A difference lies in that a thickness of coating layer is changed, and details are as follows.

In Example I9a, a total thickness of two coatings is 0.5 μm. In this case, an oil-based separator 9a was obtained.

In Example I9b, a total thickness of two coatings is 4.5 μm. In this case, an oil-based separator 9b was obtained.

Setting of parameters in specific examples is shown in Table 1.

TABLE 1

| | Second additive | | | | |
|---|---|---|---|---|---|
| | Weight-average | | | Mass ratio of the | Total thickness |
| | molecular | Dv50 | | first additive to the | of two coatings |
| | weight (Da) | (μm) | Material | second additive | (μm) |
| Example I1 | 8 × 10⁵ to 10 × 10⁵ | 3.724 | PVDF | 30:70 | 2 |
| | | | microspheres | | |
| Example I2 | 8 × 10⁵ to 10 × 10⁵ | 0.5 | PVDF | 40:60 | 1 |
| | | | microspheres | | |
| Example I3 | 8 × 10⁵ to 10 × 10⁵ | 4.5 | PVDF | 20:80 | 3 |
| | | | microspheres | | |
| Example I4a | 8 × 10⁵ to 10 × 10⁵ | 3.724 | PVDF | 90:10 | 2 |
| | | | microspheres | | |
| Example I4b | 8 × 10⁵ to 10 × 10⁵ | 3.724 | PVDF | 70:30 | 2 |
| | | | microspheres | | |
| Example I4c | 8 × 10⁵ to 10 × 10⁵ | 3.724 | PVDF | 50:50 | 2 |
| | | | microspheres | | |
| Example I5a | 8 × 10⁵ to 10 × 10⁵ | 3.724 | PVDF | 30:70 | 2 |
| | | | microspheres | | |
| Example I5b | 8 × 10⁵ to 10 × 10⁵ | 3.724 | PVDF | 30:70 | 2 |
| | | | microspheres | | |
| Example I6a | 15 × 10⁵ to 20 × 10⁵ | 3.724 | PVDF | 30:70 | 2 |
| | | | microspheres | | |
| Example I6b | 25 × 10⁵ to 30 × 10⁵ | 3.724 | PVDF | 30:70 | 2 |
| | | | microspheres | | |
| Example I6c | 6 × 10⁵ to 7 × 10⁵ | 3.724 | PVDF | 30:70 | 2 |
| | | | microspheres | | |
| Example I7a | 8 × 10⁵ to 10 × 10⁵ | 0.3 | PVDF | 30:70 | 2 |
| | | | microspheres | | |
| Example I7b | 8 × 10⁵ to 10 × 10⁵ | 10 | PVDF | 30:70 | 2 |
| | | | microspheres | | |
| Example I8a | 1 × 10⁵ to 3 × 10⁵ | 2.55 | PTFE | 30:70 | 2 |
| | | | microspheres | | |
| Example I8b | 1 × 10⁵ to 5 × 10⁵ | 3.55 | PMMA | 30:70 | 2 |
| | | | microspheres | | |
| Example 8c | 5 × 10⁵ to 8 × 10⁵ | 3.15 | PE | 30:70 | 2 |
| | | | microspheres | | |
| Example 19a | 8 × 10⁵ to 10 × 10⁵ | 3.724 | PVDF | 30:70 | 0.5 |
| | | | microspheres | | |
| Example 19b | 8 × 10⁵ to 10 × 10⁵ | 3.724 | PVDF | 30:70 | 4.5 |
| | | | microspheres | | |

### Comparative Example D1

In a slurry for coating, a solid content is 7.5%, and a solvent is DMAC. A conventional PVDF (a melting point ranges from 150° C. to 160° C., and a weight-average molecular weight ranges from 3×10⁵ Da to 7×10⁵ Da) was used as a first additive, which accounted for 37.5% of total solid mass. A viscosity of the solution ranges from 130 mPa·s to 180 mPa·s.

The slurry for coating was applied to a surface of a PE base material layer having a thickness of 5 μm (double-sided coating). The coated PE base material layer was immersed in an extraction tank (a water temperature of the extraction tank is 25° C.). A total thickness of two coatings is 2 μm. After coating, an oil-based separator 10 was obtained.

### Comparative Example D2

A first additive (conventional PVDF, with a melting point ranging from 150° C. to 160° C. and a weight-average molecular weight ranging from 3×10⁵ Da to 7×10⁵ Da), a second additive (PVDF microspheres, a melting point is 145° C.±5° C., a weight-average molecular weight ranges from 8×10⁵ Da to 10×10⁵ Da, and a median particle size Dv50 of the microspheres is 3.724 μm), styrene-butadiene rubber, and sodium carboxymethyl cellulose were used for coating and production at a mass ratio of 21:51:24:4. A separator base material is PE, with a thickness of 5 μm. A solid content of a slurry for coating is 12.5%, and a solvent is deionized water. The slurry was stirred for 60 minutes, and a viscosity of the slurry was controlled from 100 mPa·s to 150 mPa s for coating (double-sided coating). After drying, a total thickness of two coatings is 2 μm. After coating, a water-based separator 1 was obtained.

The oil-based separators prepared in Example I1-Example I9 and Comparative Example D1 and the water-based separator prepared in Comparative Example D2 were tested, and surface electrostatic average values are recorded in Table 2.

### Test Example 1

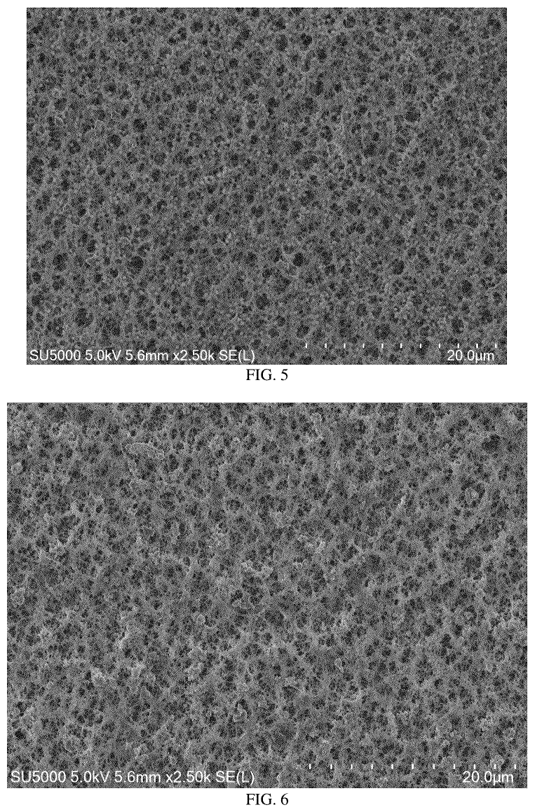

FIG. 2 to FIG. 5 are SEM diagrams of a surface of separators in Example I1 and Examples 14a-14c, where FIG. 2 is an SEM diagram of a surface of a separator in Example I4a, FIG. 3 is an SEM diagram of a surface of a separator in Example I4b, FIG. 4 is an SEM diagram of a surface of a separator in Example I4c, and FIG. 5 is an SEM diagram of a surface of a separator in Example I1. It may be learned from the SEM diagrams that mesh structures shown in FIG. 2 to FIG. 5 are formed on surfaces of separators. An organic matter functions as a skeleton between coating layers for connection, and can be partially swollen or soaked at a high temperature and for a long time and dissolved in an organic solvent (medium). When partial dissolution occurs, the organic matter can be connected to a dissolved PVDF component in a solvent around spheres, forming a unique morphology (for example, a skeleton support structure shown in FIG. 1), which is porous and has a specific skeleton structure. Pore diameter distribution of coatings was observed from the SEM diagrams of a surface of separators in FIG. 2 to FIG. 5 and recorded in Table 2, where the pore diameter refers to a diameter of a surface hole, and a diameter in a longitudinal axis direction is used as the pore diameter when a pore is oval.

FIG. 6 is an SEM diagram of a surface of the separator in Comparative Example D1. It may be learned from the SEM diagram that there is no mesh structure on the surface of the separator, and pore diameter distribution on the surface of the separator is recorded in Table 2.

### Test Example 2

### 1. Preparation of a Pouch Battery

Separator: Separators prepared in Comparative Examples D1 and D2 and Examples I1-I9 were separately selected.

Positive electrode structure: Aluminum foil with a thickness of 10 μm was used as a foil material. The positive electrode coating includes: a positive electrode active material LiCoO₂, accounting for 97.80%; a positive electrode conductive agent conductive carbon black, accounting for 1.10%; and a positive electrode binder polyvinylidene fluoride, accounting for 1.10%;

Negative electrode structure: Copper foil with a thickness of 5 μm was used as a foil material. The negative electrode coating includes: a negative electrode active material mesocarbon microbead, accounting for 96.50%; a negative electrode conductive agent carbon nanotubes, accounting for 0.90%; a negative electrode binder SBR, accounting for 1.30%; and a dispersing agent sodium carboxymethyl cellulose CMC-Na, accounting for 1.30%.

Electrolyte solution: EC:EMC:DEC=3:5:2 (mass ratio),LiPF₆ is 1.2 mol/L.

The foregoing separators were separately assembled with the foregoing positive electrode and the foregoing negative electrode to form pouch batteries, denoted as battery 1-11 (Batteries prepared by using the oil-based separators 1-9 are denoted as battery 1-9, a battery prepared by using the oil-based separator 10 is denoted as battery 10, and a battery prepared by using the water-based separator is denoted as battery 11).

### 2. Self-Discharge Test Method for a Battery Cell

32 pieces were selected from each of batteries 1-11 for performing primary formation and activation or capacity screening, then aging at 45° C. for 48 hours, and then were left to stand at room temperature for 24 hours. After that, a voltage V1 of each battery cell was measured and recorded as t1, and after 48 hours, a voltage was measured for the second time and recorded as V2, and time was recorded as t2. Thus, a self-discharge value K (unit: mV/h) of a battery cell is obtained as follows:

K=(V1−V2)/(t2−t1). An average value of values K for each group of batteries is an average self-discharge value, which is recorded in Table 2.

### 3. Core Pulling Test

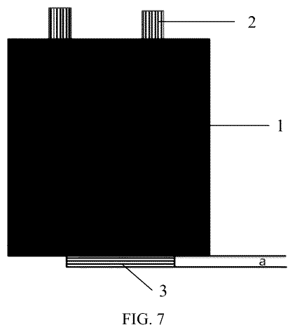

The foregoing separators were grouped for production and use in a battery cell winding process, and each group had a follow-up production volume of 3000 pieces. A core pulling phenomenon means that, in a winding process, the innermost separator is in direct contact with a winding needle, and when the winding needle is pulled out, electrostatic adsorption or dynamic friction between the separator and the winding needle is relatively large, which causes the separator to be pulled out of a jelly roll, causing core pulling of the jelly roll. For example, FIG. 7 is a schematic diagram of core pulling of a jelly roll, where a represents a length of a part, exposed outside the jelly roll, of a separator, that is, a represents a pulling distance of the jelly roll, in a unit of millimeter. When 0≤a≤0.5 mm, the jelly roll is considered qualified. When a >0.5 mm, the jelly roll is considered unqualified. A quantity of unqualified jelly rolls was recorded for calculating a defect rate according to the following formula: Core pulling defect rate=Quantity of unqualified jelly rolls/3000. The calculation results are recorded in Table 2.

### 4. Hi-Pot Test

3000 pieces for each of batteries 1-11 were selected and grouped for this test. A Hi-Pot test was performed by using an insulation resistance tester (model: HIOKI ST5520). Test conditions are as follows: a voltage is 100 V, time is 2.5 s, and a surface pressure is 0.2 Mpa. When a resistance value is greater than or equal to 2 MΩ, a battery is considered qualified. When a resistance value is less than 2 MΩ, a battery is considered unqualified. Hi-Pot defect rate=Quantity of unqualified batteries in each group/3000. The calculation results are recorded in Table 2.

TABLE 2
Test results

| | | Core | | | | |
|---|---|---|---|---|---|---|
| | | pulling | | Average | Average self- | Pore |
| | Mesh | defect | Hi-Pot | electrostatic | discharge value | diameter |
| Group | structure | rate | defect rate | value (V) | (mV/h) | distribution |
| Battery | N/A | 0.8% | 1.5% | 2900 to 3300 | 0.045 to 0.055 | 0.5 μm: 30% |
| 10 | | | | | | 1 μm: 40% |
| | | | | | | 2 μm: 15% |
| | | | | | | <0.5 μm: 15% |
| | | | | | | >3 μm: 0% |
| Battery | N/A | 1.5% | 0.8% | 70 to 150 | 0.034 to 0.036 | / |
| 11 | | | | | | |
| Battery | Existing | 0.1% | 0.3% | 270 to 350 | 0.032 to 0.034 | 0.5 μm: 17% |
| 1 | and | | | | | 1 μm: 25% |
| | obvious | | | | | 2 μm: 40% |
| | | | | | | <0.5 μm: 3% |
| | | | | | | >3 μm: 15% |
| Battery | Existing | 0.1% | 0.3% | 320 to 450 | 0.032 to 0.034 | 0.5 μm: 21% |
| 2 | and | | | | | 1 μm: 28% |
| | obvious | | | | | 2 μm: 32% |
| | | | | | | <0.5 μm: 8% |
| | | | | | | >3 μm: 11% |
| Battery | Existing | 0.1% | 0.3% | 270 to 350 | 0.030 to 0.032 | 0.5 μm: 11% |
| 3 | and | | | | | 1 μm: 25% |
| | obvious | | | | | 2 μm: 45% |
| | | | | | | <0.5 μm: 2% |
| | | | | | | >3 μm: 17% |
| Battery | With | 0.5% | 1.0% | 900 to 1200 | 0.038 to 0.042 | 0.5 μm: 22% |
| 4a | | | | | | 1 μm: 52% |
| | | | | | | 2 μm: 20% |
| | | | | | | <0.5 μm: 8% |
| | | | | | | >3 μm: 3% |
| Battery | With | 0.3% | 0.7% | 700 to 850 | 0.036 to 0.038 | 0.5 μm: 18% |
| 4b | | | | | | 1 μm: 40% |
| | | | | | | 2 μm: 30% |
| | | | | | | <0.5 μm: 7% |
| | | | | | | >3 μm: 5% |
| Battery | With | 0.1% | 0.5% | 550 to 680 | 0.034 to 0.036 | 0.5 μm: 22% |
| 4c | | | | | | 1 μm: 30% |
| | | | | | | 2 μm: 35% |
| | | | | | | <0.5 μm: 5% |
| | | | | | | >3 μm: 8% |
| Battery | With | 0.2% | 0.3% | 770 to 950 | 0.038 to 0.042 | 0.5 μm: 44% |
| 5a | | | | | | 1 μm: 15% |
| | | | | | | 2 μm: 5% |
| | | | | | | <0.5 μm: 35% |
| | | | | | | >3 μm: 1% |
| Battery | Existing | 0.5% | 0.7% | 270 to 350 | 0.032 to 0.034 | 0.5 μm: 4% |
| 5b | and | | | | | 1 μm: 25% |
| | obvious | | | | | 2 μm: 55% |
| | | | | | | <0.5 μm: 2% |
| | | | | | | >3 μm: 14% |
| Battery | Existing | 0.1% | 0.3% | 270 to 350 | 0.032 to 0.034 | 0.5 μm: 14% |
| 6a | and | | | | | 1 μm: 27% |
| | obvious | | | | | 2 μm: 42% |
| | | | | | | <0.5 μm: 2% |
| | | | | | | >3 μm: 15% |
| Battery | Existing | 0.1% | 0.3% | 220 to 310 | 0.032 to 0.034 | 0.5 μm: 13% |
| 6b | and | | | | | 1 μm: 22% |
| | obvious | | | | | 2 μm: 43% |
| | | | | | | <0.5 μm: 2% |
| | | | | | | >3 μm: 20% |
| Battery | Existing | 0.1% | 0.3% | 280 to 370 | 0.033 to 0.035 | 0.5 μm: 19% |
| 6c | and | | | | | 1 μm: 26% |
| | obvious | | | | | 2 μm: 38% |
| | | | | | | <0.5 μm: 5% |
| | | | | | | >3 μm: 12% |
| Battery | With | 0.2% | 0.5% | 290 to 370 | 0.034 to 0.036 | 0.5 μm: 21% |
| 7a | | | | | | 1 μm: 35% |
| | | | | | | 2 μm: 32% |
| | | | | | | <0.5 μm: 4% |
| | | | | | | >3 μm: 8% |
| Battery | Existing | 0.2% | 0.3% | 240 to 290 | 0.032 to 0.034 | 0.5 μm: 12% |
| 7b | and | | | | | 1 μm: 25% |
| | obvious | | | | | 2 μm: 45% |
| | | | | | | <0.5 μm: 1% |
| | | | | | | >3 μm: 17% |
| Battery | With | 0.2% | 0.7% | 300 to 380 | 0.035 to 0.037 | 0.5 μm: 19% |
| 8a | | | | | | 1 μm: 28% |
| | | | | | | 2 μm: 35% |
| | | | | | | <0.5 μm: 5% |
| | | | | | | >3 μm: 3% |
| Battery | Existing | 0.1% | 0.3% | 280 to 360 | 0.033 to 0.035 | 0.5 μm: 19% |
| 8b | and | | | | | 1 μm: 27% |
| | obvious | | | | | 2 μm: 38% |
| | | | | | | <0.5 μm: 4% |
| | | | | | | >3 μm: 12% |
| Battery | Existing | 0.1% | 0.3% | 270 to 350 | 0.032 to 0.034 | 0.5 μm: 20% |
| 8c | and | | | | | 1 μm: 26% |
| | obvious | | | | | 2 μm: 36% |
| | | | | | | <0.5 μm: 4% |
| | | | | | | >3 μm: 14% |
| Battery | Existing | 0.1% | 0.3% | 290 to 370 | 0.032 to 0.034 | 0.5 μm: 15% |
| 9a | and | | | | | 1 μm: 27% |
| | obvious | | | | | 2 μm: 38% |
| | | | | | | <0.5 μm: 4% |
| | | | | | | >3 μm: 16% |
| Battery | Existing | 0.2% | 0.3% | 270 to 350 | 0.032 to 0.034 | 0.5 μm: 15% |
| 9b | and | | | | | 1 μm: 23% |
| | obvious | | | | | 2 μm: 43% |
| | | | | | | <0.5 μm: 2% |
| | | | | | | >3 μm: 17% |

According to the test results in Table 2, it may be learned that the oil-based separator of the battery 10 has a large electrostatic value, and easily adsorbs light dust or particles, thereby causing self-discharge in the battery cell to be large. The electrostatic values of the oil-based separators of the batteries 1-9 are less than 1200 V, and electrostatic values of surfaces of the separators are relatively small, which are close to that of a water-based separator. It may be learned that, after a second additive organic microspheres are added, a unique cross-linking effect is formed in coating of a separator, so as to obtain adhesive layer holes of a separator adhesive layer according to the present disclosure. Specifically, a pore diameter of the adhesive layer holes ranges from 0.01 μm to 10 μm. Therefore, the separator adhesive layer in the present disclosure may effectively reduce an electrostatic value of coating, reduce a capability of adsorbing light and small objects/particles on a surface of the separator, and reduce self-discharge effect of a battery cell.

In this method, a surface electrostatic value may be reduced by adding a specific amount of second additive organic matter to change a surface morphology of a gravure oil-based separator, and manufacturability of the separator is increased.

In the present disclosure, organic microspheres of the second additive are introduced to a surface of the separator to form a mesh structure with a first additive, and may be used to replace ceramic particles that are currently introduced into a separator adhesive layer.

Exemplary implementations of the present disclosure are described above. However, the protection scope of the present disclosure is not limited to the foregoing implementations. Any modifications, equivalent replacements, improvements, and the like made by those skilled in the art within the spirit and principle of the present disclosure shall fall within the scope of protection of the present disclosure.

What is claimed is:

1. A separator, wherein the separator comprises a coating; the coating comprises a first additive and a second additive, and a mass ratio of the first additive to the second additive ranges from 1:9 to 9:1; and the coating comprises a plurality of adhesive layer holes, and a pore diameter of the adhesive layer hole ranges from 0.01 μm to 10 μm.

2. The separator according to claim 1, wherein a mass ratio of the first additive to the second additive ranges from 2:8 to 8:2.

3. The separator according to claim 1, wherein in the adhesive layer holes, a quantity of adhesive layer holes with a pore diameter ranging from 1 μm to 3 μm accounts for 30%-70% of a total quantity of adhesive layer holes.

4. The separator according to claim 1, wherein the second additive is organic microspheres, and the organic microspheres meet at least one of the following conditions:
a weight-average molecular weight of an organic matter in the organic microspheres ranges from 1×10⁵ Da to 30×10⁵ Da;
a median particle size Dv50 of the organic microspheres ranges from 0.1 μm to 300 μm;
a melting point of an organic matter in the organic microspheres ranges from 100° C. to 400° C.;
an organic matter in the organic microspheres is selected from at least one of a fluorine-containing polymer or an acrylate polymer;
the organic microspheres are partially or rarely dissolved in an organic solvent, to form a mesh structure; or
an organic matter in the organic microspheres is selected from at least one of polyvinylidene fluoride (PVDF), polytetrafluoroethylene, polyethylene, or polymethyl methacrylate.

5. The separator according to claim 1, wherein the second additive is organic microspheres, and the organic microspheres meet at least one of the following conditions:
a weight-average molecular weight of an organic matter in the organic microspheres ranges from 8×10⁵ Da to 10×10⁵ Da or 10×10⁵ Da to 30×10⁵ Da;
a median particle size Dv50 of the organic microspheres ranges from 0.3 μm to 10 μm;
a melting point of an organic matter in the organic microspheres ranges from 140° C. to 155° C.;
an organic matter in the organic microspheres is selected from polyvinylidene fluoride; or
the organic microspheres are partially or rarely dissolved in an organic solvent, to form a mesh structure.

6. The separator according to claim 1, wherein the first additive is connected to a surface of the second additive in a long-chain grid shape.

7. The separator according to claim 1, wherein the first additive is selected from PVDF, and has a melting point ranging from 150° C. to 160° C. and a weight-average molecular weight ranging from 3×10⁵ Da to 7×10⁵ Da.

8. The separator according to claim 1, wherein the separator comprises a base material layer and the coating located on at least one surface of the base material layer.

9. The separator according to claim 8, wherein when the coating is disposed on one surface of the base material layer, the separator comprises one coating, and a thickness of the one coating ranges from 0.1 μm to 3 μm;
when the coating is disposed on two surfaces of the base material layer, the separator comprises two coatings, and a total thickness of the two coatings ranges from 0.2 μm to 5 μm.

10. The separator according to claim 8, wherein when the coating is disposed on one surface of the base material layer, the separator comprises one coating, and a thickness of the one coating ranges from 0.8 μm to 1.2 μm;
when the coating is disposed on two surfaces of the base material layer, the separator comprises two coatings, and a total thickness of the two coatings ranges from 1.8 μm to 2.2 μm.

11. The separator according to claim 8, wherein a thickness of the base material layer ranges from 1 μm to 30 μm; and/or
the base material layer is selected from a single-layer base material layer or a multi-layer base material layer formed by polyethylene (PE) and/or polypropylene (PP).

12. The separator according to claim 8, wherein the base material layer is selected from a three-layer base material layer of PP/PE/PP.

13. The separator according to claim 1, wherein the separator is an oil-based separator.

14. The separator according to claim 1, wherein an average electrostatic value of the separator is less than 1500 V.

15. The separator according to claim 1, wherein an average self-discharge value of the separator is less than 0.045 mV/h.

16. A lithium-ion battery, wherein the lithium-ion battery comprises the separator according to claim 1.

17. The lithium-ion battery according to claim 16, wherein the lithium-ion battery further comprises a positive electrode, and the positive electrode comprises at least a positive electrode current collector, a positive electrode coating, and a positive tab; and
preferably, a thickness of the positive electrode current collector ranges from 8 μm to 14 μm.

18. The lithium-ion battery according to claim 17, wherein the positive electrode coating comprises a positive electrode active material, a positive electrode conductive agent, and a positive electrode binder; and
preferably, in the positive electrode coating, a mass fraction of the positive electrode active material ranges from 96% to 98.5%, a mass fraction of the positive electrode conductive agent ranges from 0.5% to 2.5%, and a mass fraction of the positive electrode binder ranges from 1% to 1.5%.

19. The lithium-ion battery according to claim 16, wherein the lithium-ion battery further comprises a negative electrode, and the negative electrode comprises a negative electrode current collector, a negative electrode coating, and a negative tab.

20. The lithium-ion battery according to claim 19, wherein the negative electrode coating comprises a negative electrode active material, a negative electrode conductive agent, a negative electrode binder, and a dispersing agent; and
preferably, in the negative electrode coating, a mass fraction of the negative electrode active material ranges from 95% to 97%, a mass fraction of the negative electrode conductive agent ranges from 1% to 2%, a mass fraction of the negative electrode binder ranges from 1% to 1.5%, and a mass fraction of the dispersing agent ranges from 1% to 1.5%.
